(19) United States
(12) Patent Application Publication
(10) Pub. No.: US 2008/0017561 A1
(43) Pub. Date: Jan. 24, 2008

(54) Combined filtration and anti-microbial treatment trench filter device for storm water pipes and drainage trenches

(76) Inventors: Mark D. Shaw, Ponte Vedra Beach, FL (US); J. Tad Heyman, Atlantic Beach, FL (US); Laurence M. Bierce, Steinhatchee, FL (US)

Correspondence Address: ROGERS TOWERS, P.A., 1301 RIVERPLACE BOULEVARD, SUITE 1500, JACKSONVILLE, FL, 32207, US

(21) Appl. No.: 11/488,219

(22) Filed: Jul. 18, 2006

(51) Int. Cl. B01D 35/00

(52) U.S. Cl. 210/162; 210/170.07

(57) ABSTRACT

A combination filtration and anti-microbial trench filter disposed in a pipe of a storm water system such that, in addition to removing hydrocarbon and liquid organic contaminants, the concentration of bacteria in storm water is severely reduced or eradicated. The trench filter comprises an elongated spine member, a plurality of flaps attached to the spine member and retaining anti-microbial agents, and rib members disposed in the flaps and extending radially from the spine member.

### BACKGROUND OF THE INVENTION

This invention relates generally to the field of filtration of storm water run-off as captured, controlled and transported by storm water drainage systems. More particularly, the invention relates to the field of means to filter storm water or surface water run-off to remove hydrocarbons, organic liquids and particulate matter, as well to eradicate bacteria in the storm water run-off. Even more particularly, the invention relates to devices known as trench filters that are disposed within drainage trenches or storm water pipes.

As a result of society's high level of use of products containing hydrocarbons or organic liquids, it is not uncommon for such components to be flushed in significant amounts into storm water drainage systems. It is therefore necessary to provide means and methods to remove such contaminants from the storm water prior to discharge of the storm water from the storm water system. In a common approach filtration means capable of capturing the hydrocarbons and organic liquids are disposed at the ingress points of the storm water system, i.e., filter means are positioned in the storm drains such that the contaminants are immediately captured and storm water passing into the storm water drainage system is relatively contaminant-free. In another method, filtration means are positioned at the points of exit of the storm water system, such that the contaminants are removed prior to discharge into the environment. It is also known to provide trench or pipe filters that are positioned within the pipes and conduits of the storm water system, such as for example a device sold under the brand ULTRA-TRENCHFILTER by UltraTech International. The trench filter devices comprise a relatively large number of carrier members, such as strips or flaps of filter material, that are connected to an elongated member such as a rope, cable or the like. The trench filter is disposed generally axially within the pipe or trench and secured at the ingress end of the pipe or trench.

Another problem inherent in storm water discharge is microbial contamination. Bacteria in relatively high concentration may in some circumstances be flushed into the storm water system, but significant microbial contamination of discharge water also results from the fact that storm water systems comprise vast networks of storm drains, conduits, collectors and the like. All storm water run-off entering a storm water system does not pass fully through the system in a single storm event. Instead there are large numbers of areas where the storm water remains resident in the system for extended periods of time. For example, the outlet pipes at the base of storm drains is typically connected to the catch basin several inches above the bottom of the basin. This results in several inches of water that remaining trapped in the bottom or sump of each catch basin after a storm. Also, the pipes and conduits used to transport and discharge the storm water from the system may be improperly installed or shift over time such that the desirable down-slope is not present such that some water remains in these areas rather than flowing downstream. This resident water is prime breading ground for bacteria, to the point that the bacterial concentration discharging from the storm system after large rains may exceed safe limits.

Providing anti-microbial agents in combination with filtration media at the ingress or discharge points of the storm system, i.e., the storm grates or curb inlets, does not adequately address this problem, as the amount of time that the bacteria is in contact with the anti-microbial agents in these pass-through catch basin filters is extremely short, and thus the effectiveness of the anti-microbial action is very limited. Furthermore, if only ingress filters are utilized, the anti-microbial agents in the ingress filters do not address the problem of microbial growth in sump areas within the storm water system. The high amounts of bacteria that grow in the sump areas after a first storm event are flushed from the system by subsequent storm events. While efforts have been made to address the issue of microbial growth in sump areas of underground storm systems, there is also a need to address microbial contamination of water passing through underground pipes and surface drainage trenches or ditches, where water may or may not remain resident between storm events.

It is an object of this invention therefore, to provide a means for effectively reducing the bacterial concentration in storm water discharge by providing an improved trench filter. This is accomplished by providing a combination filtration and anti-microbial device that, in addition to removing hydrocarbon and liquid organic contaminants and eradicating microbes as the storm water passes across the trench filter, effectively reduces the concentration of bacteria in any storm water that remains resident in the storm water conduits. The combination filtration and anti-microbial device remains disposed in the resident water, thereby increasing the contact time between the anti-microbial agents and the bacteria such that large amounts of bacteria are eradicated and explosive bacterial growth within the sump areas is precluded. It is a further object to increase the effective life of the filtration media by reducing the growth of bacteria, mold, algae and the like on the filtration media itself. It is a further object to improve upon the effectiveness of known trench filters by providing structural members to maintain the filter material in an expanded or spread configuration.

### SUMMARY OF THE INVENTION

Bacterial discharge from a storm water system is eradicated or severely reduced in concentration by providing a trench or pipe filter that is a combination filtration and anti-microbial device that is disposed in the drainage ditches, trenches, pipes or conduits of the storm water system such that, in addition to removing hydrocarbon and liquid organic contaminants, the concentration of bacteria in storm water that passes through the system and that remains resident in the ditches or pipes after a storm event is severely reduced or eradicated. The anti-microbial agent is adhered to, combined with, impregnated in, contained in carrier materials or beads retained by the filtration fabric, or otherwise joined to the filtration media. The preferred filtration media is composed of fibers or the like, formed for example of polypropylenes or polyesters, that have as a property an affinity to adsorb hydrocarbons and liquid organic contaminants.

The invention comprises a trench filter similar in construction to known trench filters, in that the device comprises an elongated cord or spine member having a filtration medium attached along its length, the filtration medium being slotted such that multiple strips extend radially from the spine member. Preferably, the strips are composed of a filtration medium that removes hydrocarbons and organic liquids from the storm water, but the strips may also be composed of any suitable matrix or carrier material to support the anti-microbial agent. The trench filter is further improved by providing structural or rib members that are attached to each filtration strip and extend radially from the spine member. In this manner the filtration strips remain extended transverse to the water flow direction rather than being oriented in the downstream direction.

### BRIEF DESCRIPTION OF THE DRAWINGS

FIG. 1 shows a portion of a trench filter incorporating rib members.

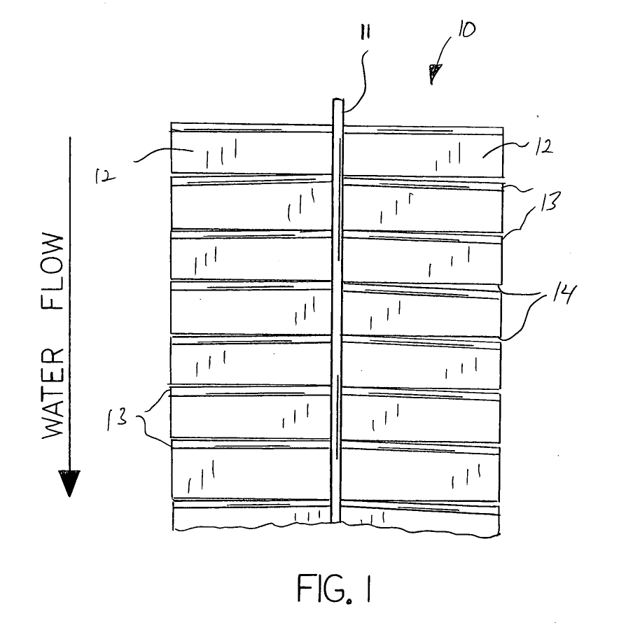

### DETAILED DESCRIPTION OF THE INVENTION

The invention is in general a trench filter device for severely reducing or eliminating hydrocarbon, liquid organic, and bacterial contamination of storm water discharging from a storm water system into the environment.

Storm water systems are well known and extremely common, typically consisting of large of numbers of storm drains and catch basins located in roadway curbs, within large paved areas such as parking lots, in drainage ditches, and the like. The storm drains allow the storm water to fall into catch basins. Conduits are connected to the catch basins to transport the storm water to discharge points where the storm water is returned to the environment. A storm water system is a vast network, and there are numerous recessed areas that act as sumps, either intentionally or unintentionally, where storm water remains resident within the system for extended periods of time, or at least until a subsequent storm event occurs. Such sumps occur in the pipes and conduits due to improper installation or shifting over time. Because the water may remain in these sumps for extended periods of time, and because the sumps will not necessarily be completely flushed upon subsequent storm events, the water retained in the sumps is prime for bacterial growth. This can result in an extremely high bacterial concentration in the discharge water when flushing of the storm system occurs. In other storm systems, surface ditches or trenches are utilized. These ditches and trenches are likewise susceptible to unacceptable bacterial growth in resident water trapped between storm events.

The invention solves the problem of excessive microbial ocntamination by providing an improved trench filter preferably comprising a combination filtration and anti-microbial medium that is positioned resident in the storm water pipes or ditches. The combination filtration and anti-microbial device is thus a resident filter and treatment means as well as a pass-though filter and treatment means. While the filter material may comprise many suitable materials capable of entrapping particulate matter, it is most preferable that the filter material acts as an effective means to adsorb hydrocarbon and liquid organic contaminants, as the presence of these components in discharge water is also undesirable. Many polypropylenes and polyesters, for example, are known to possess this adsorptive property.

The anti-microbial agent may be any of many suitable compositions, such as for example but not limited to an organosilane antimicrobial agent as disclosed in U.S. Pat. No. 5,954,869, the disclosure of which is incorporated herein by reference, which is suitably bonded, adhered, grafted, impregnated or otherwise joined to the filter material. The term anti-microbial is meant herein to include any compound, product, composition, article, etc., that reduces the growth and proliferation of microbial organisms, including but not limited to bacteria, viruses, protozoa, molds and the like. The anti-microbial agent is most preferably chosen from the group of such agents that are water-stable, such that the agent does not dissolve, leach or permeate into the storm water.

The trench filter 10 comprises an elongated cord or spine member 11 to which are attached a large number of filtration flaps 12, preferably formed by creating radially disposed slits 14 in sheet material attached to the spine member 11. The spine 11 may be formed of a flexible material, such as a rope or chain, or a rigid material, such as a PVC pipe. Means to the secure the device within a pipe or trench may also be provided. Water flowing through the pipes contacts the filtration flaps 12, such that particulate matter, hydrocarbons, organic liquids and other contaminants are captured prior to discharge of the water into the environment.

To improve this trench filter 10, an anti-microbial agent is incorporated in or on the filtration flaps 12. To further improve on the trench filter 10, radially extending rib or structural support members 13 of a rigid or semi-rigid composition are provided in the filtration flaps 12, preferably in the leading edges subject to water flow. Rib members 13 may be composed for example of PVC or similar material having suitable rigidity. The rib members 13 may extend completely across the spine member 11 so as to support two flaps 12. With this construction, the filtration flaps 12 will not be swept or oriented downstream by the force of the water, resulting in a generally axial orientation having smaller effective surface area and less contact with the water, but instead will remain disposed generally transversely or perpendicularly to the water flow direction in order to maximize the filtration and anti-microbial treatment effects by increasing the contact surface area and contact time of moving water.

Furthermore, as the trench filter 10 remains disposed within the pipe or trench, any water retained therein between storm events will remain in contact with some of the filtration flaps 12 containing the anti-microbial agents so as to eradicate or severely reduce the microbial concentration in the retained water. The trench filter 10 is left in the pipe until its effectiveness becomes diminished or until the filtration flaps 12 are filled with particulates, at which time it is replaced. In this manner, storm water remaining in the pipe is constantly treated such that the concentration of microbes is severely diminished or reduced to zero prior to the water being flushed from the system by the next storm event. In addition, the filter media removes by adsorption hydrocarbon and organic liquid contaminants in the sump water. The presence of the anti-microbial agent also prolongs the effective life of the filter media itself, since growth of bacteria, mold or other microbial species on the filter media that may interfere with the filtering effectiveness is precluded.

In certain instances it may be beneficial for the trench filter 10 to float, such as by providing a means to provide the spine 11 as a buoyant member, such that for higher water situations the spine 11 remains at or near the surface and the flap members 12 hang downwardly into the water. The spine 11 may comprise a sealed air chamber or may be made of material that is naturally buoyant. Alternatively, separate floatation means may be attached to the spine 11.

While the methodology and means has been described as a combination filtration and anti-microbial medium, it is also possible to accomplish the anti-microbial effect in the pipe utilizing a trench filter made of a non-filtering fabric or other matrix to carry the anti-microbial agents without filtration properties.

It is contemplated that equivalents and substitutions for certain elements set forth above may be obvious to those skilled in the art, and therefore the true scope and definition of the invention is to be as set forth in the following claims.

We claim:

1. An improved trench filter for treatment of storm water in storm water pipes or trenches, said trench filter comprising an elongated spine to which are attached a plurality of flap members, said flap members comprising an anti-microbial agent.

2. The trench filter of claim 1, wherein said flap members are composed of a filtration material.

3. The trench filter of claim 2, said filtration material possessing hydrocarbon and liquid organic adsorption properties.

4. The trench filter of claim 1, further comprising structural support members attached to said flap members to maintain said flap members extended away from said spine.

5. The trench filter of claim 4, wherein said structural support members extend radially from said elongated spine.

6. The trench filter of claim 2, further comprising structural support members attached to said flap members to maintain said flap members extended away from said spine.

7. The trench filter of claim 6, wherein said structural support members extend radially from said elongated spine.

8. The trench filter of claim 3, further comprising structural support members attached to said flap members to maintain said flap members extended away from said spine.

9. The trench filter of claim 8, wherein said structural support members extend radially from said elongated spine.

10. The trench filter of claim 1, wherein said anti-microbial agent is water-stable and does not dissolve, leach or permeate into the storm water.

11. The trench filter of claim 2, wherein said anti-microbial agent is water-stable and does not dissolve, leach or permeate into the storm water.

12. The trench filter of claim 3, wherein said anti-microbial agent is water-stable and does not dissolve, leach or permeate into the storm water.

13. The trench filter of claim 4, wherein said anti-microbial agent is water-stable and does not dissolve, leach or permeate into the storm water.

14. The trench filter of claim 1, wherein said trench filter floats.

15. The trench filter of claim 14, wherein said spine is composed of a buoyant material.

16. An improved trench filter for treatment of storm water in a storm water pipe or trench, said trench filter comprising an elongated spine to which are attached a plurality of flap members composed of a filtration material, said flap members comprising an anti-microbial agent that is water-stable and does not dissolve, leach or permeate into the storm water, and structural support members attached to said flap members to maintain said flap members extended away from said spine, whereby said trench filter is disposed in an elongated manner within said pipe or trench so as to contact flowing storm water and resident water.

17. The trench filter of claim 16, said filtration material possessing hydrocarbon and liquid organic adsorption properties.

18. The trench filter of claim 16, wherein said structural support members extend radially from said elongated spine.

19. The trench filter of claim 16, wherein said trench filter floats.

20. The trench filter of claim 19, wherein said spine is composed of a buoyant material.
